(19) United States
(12) Patent Application Publication
(10) Pub. No.: US 2024/0395429 A1
(43) Pub. Date: Nov. 28, 2024

(54) ARMOR -ARchitectural Melanin-Operated Radiation shielding for flexible structures

(71) Applicant: Eszter Gulacsi, Caselle Torinese (IT)

(72) Inventor: Eszter Gulacsi, Caselle Torinese (IT)

(21) Appl. No.: 18/202,133

(22) Filed: May 25, 2023

(51) Int. Cl. G21F 1/10; G21F 3/00

(52) U.S. Cl. CPC G21F 1/10; G21F 3/00

(57) ABSTRACT

The will to explore in humans was driven by necessity in the early years of civilisation. From the Polynesians, Vikings, and Columbus to the common men who ventured from the east coast of America to the west, they explored whilst risking their lives and not knowing whether their efforts and persistence to overcome all the challenges would bring reward. Of course, the advertised reason for these adventures was to gain further resources, wealth, national pride or in some cases, a new start but the drive behind this tenacity is always the need to explore. Humanity has not yet explored every corner of Earth, but we still desire to go further beyond the confines of our planet and into space. We have developed ways to survive and, potentially, thrive in orbit, and there are space stations being manufactured, space habitats and establishments on planetary bodies are being designed. There are also numerous probes exploring the solar system for us, including semi-automated rovers gathering information and samples to study on Mars, but now in situ human exploration is merely years away. There are means to ensure protection against space radiation on an extraterrestrial body or temporarily in orbit where the atmosphere shields against the most extreme radiation, but hitherto there exists no plan for shielding against the harsh radiation environment during the 384,400 km trip to the Moon or the 97 million km journey to Mars. The previously introduced FORT shield can be installed on rigid structures, while ARMOR shielding is being developed for inflatable habitats. Both shielding intend to use microbiology to enhance the properties of materials and take advantage of the radiation shielding capabilities of fungi. ARMOR shielding is a silicone-coated high-performance polymer fabric with embedded melanin layer. Keywords: fungi, melanin, space radiation, deep space, inflatable habitats, architectural radiation shielding, space exploration, human spaceflight

ARMOR shielding is an architectural space radiation shielding to be used for inflatable habitats in order to establish a space habitat protected from space radiation (both solar radiation and Galactic Cosmic Rays). The shielding can be folded with the inflatable habitat to launch into space and inflated with the habitat's structure. It can also be repaired in space by 3D printing any damage done by micrometeorites, space debris or any other damage. The ARMOR shielding is made up from space graded materials, a textile core that is coated by PDMS (Polydimethylsiloxane) silicone with melanin powder mixed into the top layer of the silicone to create a layer of radiation protection.

The PDMS silicone used is SYLGARD 184 by Dow.

The prototype was made by using Vectran™ fabric but Dyneema® or Spectra® fabric can also be used. It's useful to have white or whitish-coloured fabric so their is clear contrast between the background and the melanin powder.

The coating technique used in the following description is also developed by the inventor, Eszter Gulacsi and is called peel-off coating.

It requires a peel-off paper which can be a glass sheet (bigger than the textile intended to be coated) or a big enough paper sheet sprayed by polytetrafluoroethylene (PTFE).

Part of the thoroughly mixed and degassed PDMS is poured slowly onto the peel-off paper (less likely to create new bubbles if it is poured close to the surface). The textile should be laid on top of the silicone, using a glass rod with spacers on each end can be used to roll the textile flat (FIG. 2) and into the silicone, then leave it for 10 minutes before peeling the textile off the silicone by grabbing one corner of the textile with a tweezer and slowly rolling it upwards. Rushing or not rolling would result in bubbles and uneven coating.

Another key piece of information is the PDMS silicone's alien state, which determines the consistency when the silicone is mostly cured but it still sticks to a tweezer or glass rod and only releases the object when it is lifted 2-3 cm above the silicone surface when the silicone seamlessly blends back.

Set the oven for 70° C.

ARMOR shielding's protective layer is made in 2 steps to create the 3 layers of the shielding. Working with 3 layers requires more work and precision but it can allow a thinner silicone coverage which would lower the mass and increase the flexibility of the shielding.

The third of the prepared PDMS is used to coat the chosen textile while a thin layer (2-3 mm) of PDMS is poured into the aluminium or glass dish (the same size as the textile). Sprinkle the melanin powder (the amount depends on the size of the panel) as uniformly as possible (micro-sieve can help) on top of the silicone layer in the dish and using a glass rod thoroughly mix the melanin with the silicone until a uniform, black layer is formed.

Place the dish with the black silicone into the oven for 5 min (70° C.), then remove the dish from the oven and mix the melanin if necessary as melanin tends to form clusters in liquids. Repeat it (put the dish into the oven for 3-5 min then check the uniformity) until the silicone turns alien-like. This is when the silicone still capable of blending with more PDMS silicone but the melanin particles are surrounded by mostly cured silicone.

Pour the rest of the silicone on top of the black protective layer (this is where the thickness of the shielding can be adjusted) and peel off the textile from the silicone on the peel-off paper/glass sheet. Gently, by holding 2 diagonal corners of the coated textile with tweezers, lay down the coated textile on top of the freshly poured PDMS silicone. The same side that was towards the peel-off paper should be in touch with the PDMS silicone in the dish.

Place the dish into the oven and turn up the temperature from 70° C. to 100° C. Leave it for 60 min, then remove it and let it cool entirely before removing it from the dish.

The first full prototype of ARMOR shielding is shown on FIG. 3.

### Results

Vectran™ fabric seems to offer the best result in tensile strength, abrasion resistance, outgassing, chemical and radiation resistance, impact strength. Vectran™ does not provide the highest marks in every box but overall it might be the best fabric for the intended purpose.

The most consistent and uniform coating technique turned out to be the newly developed Peel-off coating (FIGS. 4 and 5). It also requires probably the least amount of silicone which would decrease the mass and cost of the material. The coating technique might be new but the ratio of curing agent and elastomer base I found the best is the recommended 1:10.

According to the microscope images of the initial tests, shown below (FIGS. 4 and 5), the silicone layer can be torn off the filaments of the fabric by cutting the sample, which indicates that the bonding between the silicone and the filament isn't necessarily strong when the sample is cut but the bond seems to be stronger when the textile is coated with Peel-off technique.

Melanin distribution is very important as it defines the layer of the actual shielding. I found that uniform sprinkling requires a sieve, the same way as experts use a sieve to distribute powdered sugar on a baked item. Unfortunately, we can not fill the sieve with melanin (it would be a waste of material) therefore, it is wise to use a small spoon or measuring boat above the sieve (in my case, a tea egg). However, until we can not prevent the melanin to form clutter during curing it is recommended to mix the melanin powder with the silicone by using a glass rod. To ensure that it remains fully mixed, it should be checked every 3-5 min while it is cured in an oven. The cluttering also happens on room temperature.

The PDMS needs to be poured slowly and as close to the surface as possible to avoid forming bubbles (which we spent time to painstakingly remove earlier). It also needs to be left to spread evenly on its own, that will ensure uniformity.

According to the Safety Data Sheet for SYLGARD 184 supplied by Dow, the curing time for PDMS is 35 min on 100° C. but for experiments, this 35 min is more likely 8-10 min on 100° C. The manufacturer probably provided this data for the full mechanical curing. It's wiser to cure the PDMS on 70° C. for 8 minutes and then checked every 3-5 min until it reaches the consistency required.

Scaling up from 5×5 cm to 10×10 cm sample is not as straightforward as 4 times of the amounts of the different materials. The amount of silicone and melanin necessary for a 10×10 cm sample will need to be perfected.

### REFERENCE TO DRAWINGS

FIG. 1.—Schematized flow chart of the procedure of creating a prototype of ARMOR Shield. From left to right: Coat an 8×8 cm fabric (Vectran™) as described in the specification using the peel-off technique, with the melanin powder uniformly mixed into the top layer. Once fully cured, it is ready to be irradiated at a radiation lab.

FIG. 2.—Schematic section of an inflatable habitat using Sierra Space's LIFE habitat as an example. From inside to outside a general inflatable habitat has a pressurized inner layer, a fire retardant middle layer and a protective outer layer. A pre-fabricated ARMOR layer can protect the inflatable habitat from radiation and impact, and can an additional silicone-melanin layer can be printed on top. Any damage can be repaired by printing the silicone-melanin mixture.

FIG. 3.—Blown-up detail of the layers of ARMOR Shield showing the different layers and the desired position of the melanin layer.

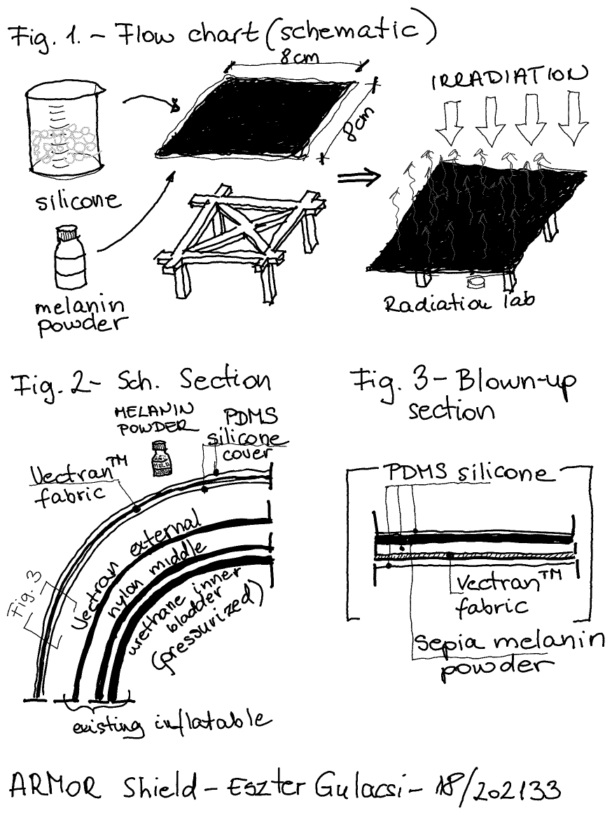

1. The application of research science in order to create architectural radiation shielding for flexible structures in order to protect humans and sensitive equipment from radiation.
